(19) United States
(12) Patent Application Publication
(10) Pub. No.: US 2007/0163829 A1
(43) Pub. Date: Jul. 19, 2007

(54) Vehicle comprises a wind turbine coupled to an electrical generator

(76) Inventor: Brian Ellis, Norfolk (GB)

Correspondence Address: BRUCE E. LILLING;LILLING & LILLING PLLC, P.O. BOX 560, GOLDEN BRIDGE, NY, 10526, US

(21) Appl. No.: 11/568,524

(22) PCT Filed: Apr. 25, 2005
(86) PCT No.: PCT/GB05/01576

§ 371 Date: Oct. 31, 2006

(30) Foreign Application Priority Data
May 1, 2004 (GB) 0409848.9

(51) Int. Cl. B60K 25/10

(52) U.S. Cl. 180/165

(57) ABSTRACT

A vehicle comprises an air flow to electrical energy converter configured to be driven primarily by the air through which a vehicle travels.

### FIELD OF THE INVENTION

The invention relates to vehicles with an environmentally friendly aspect to their power consumption. Throughout this specification the term ‘vehicle’ is to be interpreted broadly and is intended to include at least the following: trucks, motor cars, vessels (air, land or water going), trains, trailers and individual wagons.

### BACKGROUND TO THE INVENTION

The closest prior art known to the applicants are wind turbines located on floating pontoons. These typically incorporate a long mast at the end of which the turbine is located so as to avoid harming any operators who would be on the pontoon. These are provided to capture the energy from gusts of wind.

### SUMMARY OF THE INVENTION

In its broadest aspect, the invention provides a vehicle comprising an airflow to electrical energy converter configured to be driven primarily by the air through which a vehicle travels. This configuration allows a vehicle to convert the energy arising when a vehicle dissects the air during its motion into a reusable electrical energy. This configuration would be particularly advantageous for driving refrigerator units, on-board computer, machinery, telecommunications units and other control equipment. It would reduce the fossil fuel requirements of the vehicle without significantly affecting the aerodynamic properties of the vehicle. The levels of noise generated is thought to be minimal as compared to combustion explosion driven generators.

In a subsidiary aspect in accordance with the invention's broadest independent aspect, the converter incorporates a turbine located down stream from a vehicle's spoiler and positioned so that only a portion of tie turbine is exposed to the air. Locating the turbine in this position will maximise tie electrical energy obtained whilst minimising any potential aerodynamic drawback of utilising a turbine.

In a further subsidiary aspect, a duct is provided to channel air to a turbine of said converter. This configuration is particularly advantageous because of its inherent accident protective properties. It is also thought that using a duct will limit the risk of tampering occurring whilst this arrangement would still provide considerable savings in fossil fuels.

In a further subsidiary aspect, the converter incorporates a turbine whose axis of rotation is substantially parallel to the surface of the vehicle and substantially perpendicular to the direction of motion. This marks a complete departure from the prior art teaching, for example, in the field of jet aerplanes of having turbines located parallel to the surface of the plane with their axis of rotation in the direction of motion. Unique advantages of this configuration come to light particularly in tie field of railway carriages and truck trailers.

In a further subsidiary aspect, tie converter incorporates at least one turbine in the horizontal direction and another turbine in the vertical direction. This configuration is particularly advantageous because it allows energy to be captured from several faces of a vehicle as air flows across all faces of the vehicle during use.

In a further subsidiary aspect, tie converter stores energy in a battery located in the chassis of the vehicle. This feature is particularly advantageous, it will assist in lowering the centre of gravity of the vehicle which may be extremely useful in truck trailers when exposed to high winds whilst in motion.

In a further subsidiary aspect, means are provided to adjust the relative position of the spoiler and turbine during the motion of the vehicle. This would allow an optimum amount of energy to be converted despite fluctuations in environmental conditions but also in the relative position of say, the vehicle's driver cabin and its trailer.

### BRIEF DESCRIPTION OF THE FIGURES

FIG. 1 shows a schematic side view of a vehicle in accordance with the first embodiment of tie invention.

FIG. 2 shows a partial perspective view of a trailer in a second embodiment of the invention.

FIG. 3 shows a side schematic view of a truck in accordance with a third embodiment of the invention.

FIGS. 4a, 4b and 4c show respectively a side view of a railway carriage, a partial side view of a further railway carriage and a front view of a railway carriage.

### DETAILED DESCRIPTION OF THE FIGURES

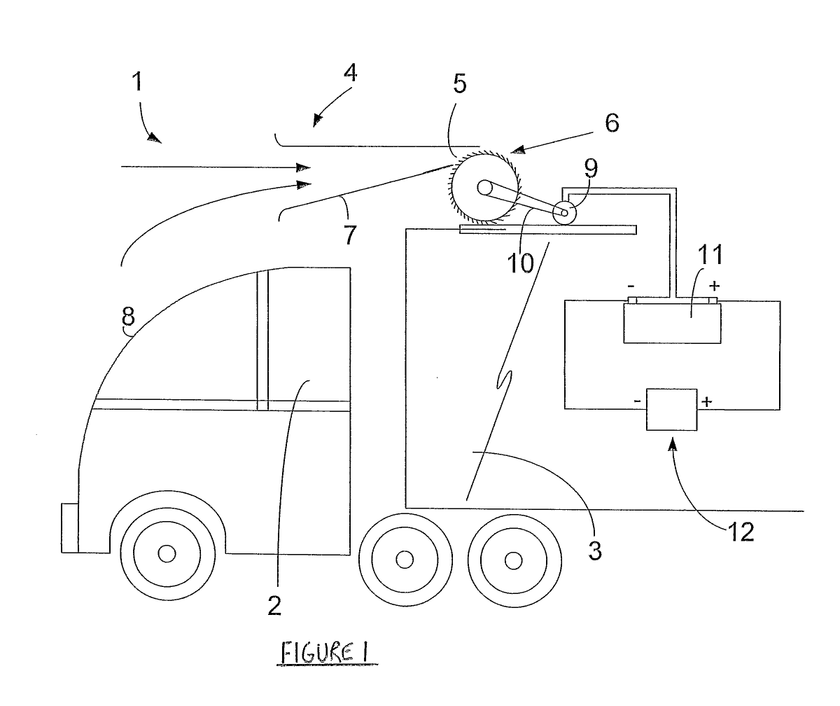

FIG. 1 shows a truck generally referenced 1 with a driver's cabin 2 and a trailer 3. Overhanging tie front portion of trailer 3 and above the rear portion of the cabin 2, a duct 4 is provided to channel air and progressively accelerate air towards its exit point 5 where it will drive the rotation of a turbine 6. Duct 4 may be a narrowing duct with a lower portion 7 essentially in line with the front curve 8 of tie driver's cabin. This minimises any trade-off between wind resistance and electricity generation. The rotary motion inflicted by the air on the turbine may be transmitted to an electrical generator 9 by a direct belt drive 10. The belt drive may be equipped with or without a variable speed device. The belt may be a chain. A gear box may also be employed to allow the system to cope with sudden fluctuations in power generation. The electrical generator may also be located at the end of the rotating shaft in a direct link if appropriate.

The electricity generated may be alternative current (AC) or direct current (DC). the electricity generated may be either directly fed into an electricity consuming apparatus or stored into a bank of batteries. Regulators, rectifiers and stabilisers may be employed alongside the generator to optimise the storage of electricity over a given period of operation.

It is envisaged that the batteries 11 would feed electricity to a cooler unit 12 which is envisaged to be located as part of tie trailer in FIG. 1.

An electric sensor is thought to be provided to monitor, record or control how the system works. This information may be used by an engineer during servicing if appropriate. The electronic sensors may contribute the information to the truck's engine management system which may choose to use electricity generated for the driver's cabin if appropriate or any other purpose dependent on the particular requirements of a given engine management system.

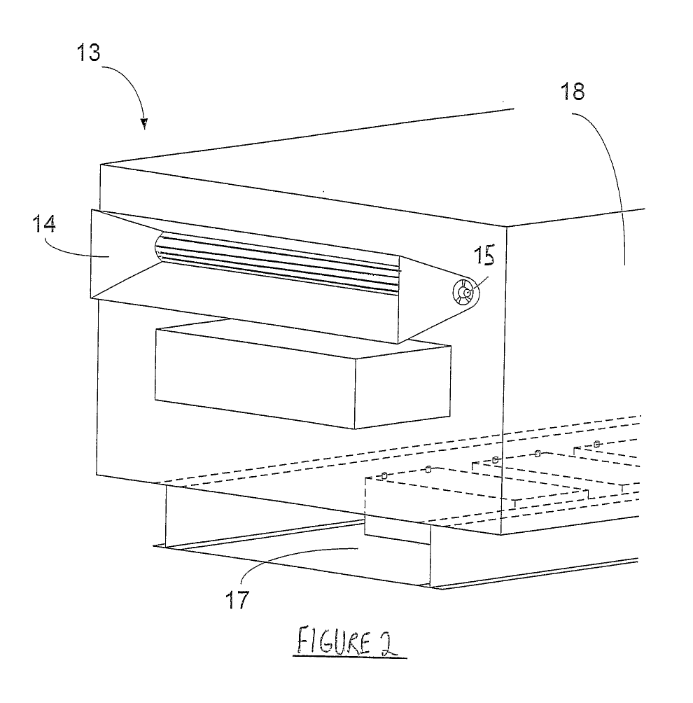

FIG. 2 shows a trailer 13 with a duct 14. The duct stretches almost the entire width of the trailer to maximise energy conversion. A turbine 15 whose rotary axle is parallel to the end face 16 of the trailer is rotated during tie motion of the trailer. The electricity generated by the rotation of turbine 15 may be stored in several batteries located in a compartnment 17 located below the conventional load carrying chamber 18. This allows the incorporation of the air to electricity converter without occupying the conventional storage face. In this particular embodiment, the air flow to electrical energy converter is incorporated entirely as part of the trailer which has no living accommodation.

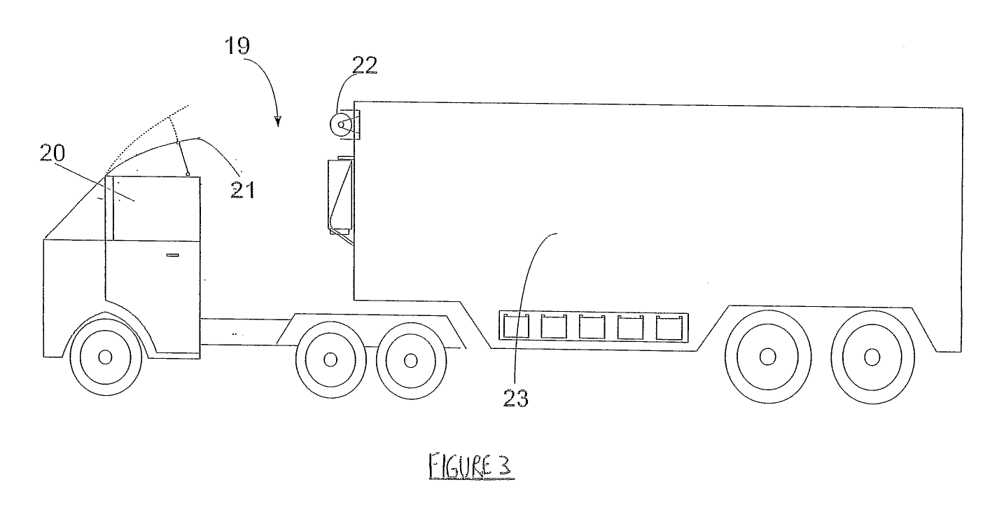

FIG. 3 shows a further truck generally referenced 19. The driver's cabin 20 incorporates a spoiler 21 which may be adjusted to take into account different positions of fan generators 22 on trailers. The trailer 23 of FIG. 3 uses both a horizontally mounted fan generator and a vertically mounted fan generator. This would allow greater total electricity generation. fan generator and a vertically mounted fan generator. This would allow greater total electricity generation.

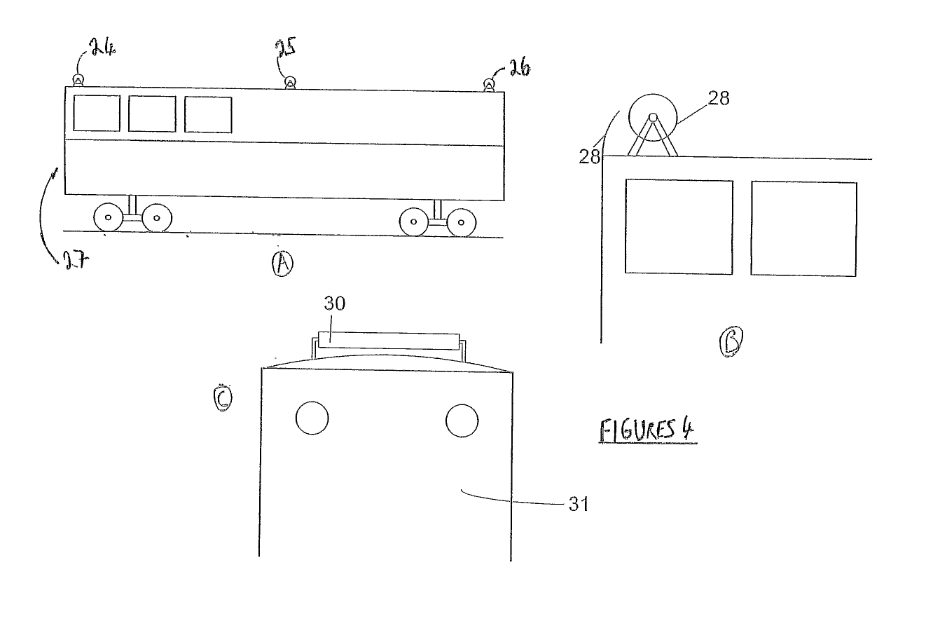

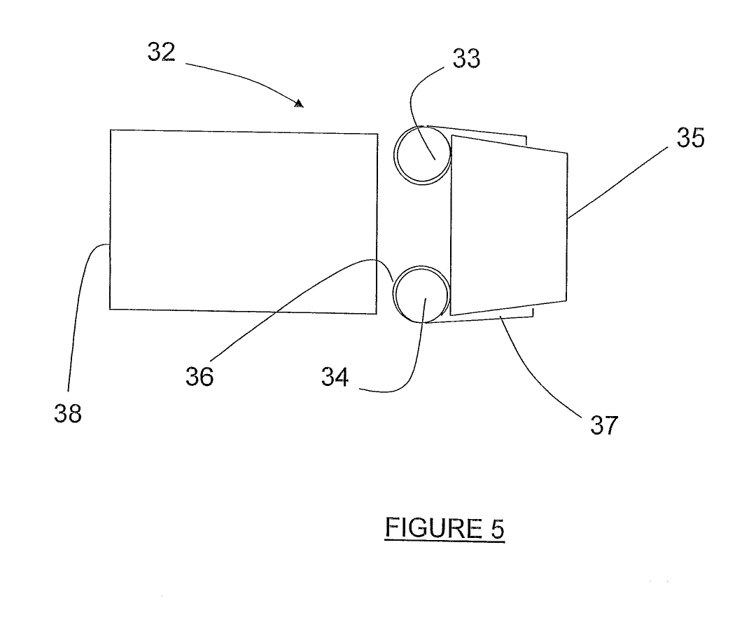

FIG. 4a shows a railway carriage 27 with a series of three horizontal fans 24, 25 and 26. All three of these fans are mounted on the roof perpendicular to the direction of motion of the carriage.

FIG. 4b shows the use of a deflector 28 with a fan 29. It is thought to be particularly advantageous to have deflector 28 being capable of being increased or decreased either telescopically or by any other means in order to allow an operator to optimise the operation of the converter.

FIG. 4c shows a typical horizontally mounted fan 30 on a railway carriage 31. It is thought that this configuration will be able to operate even when a train travels through a tunnel. The invention also envisages that tamper evident seals may be used on all vents in any of the above embodiments. The turbines employed in the above embodiment may be open or closed, vertical or horizontal whilst being made of any appropriate material selected by the person skilled in the art from known materials. Composites may have particular applications in this invention.

The turbines may also be located on adjustable mounts to allow turbines to be upgraded or removed as appropriate. Whilst in FIG. 4, the turbine has been illustrated on the roof of a carriage, these may be located on the side or underneath the vehicle.

A specific configuration of a truck 32 with side vertical turbines 33 and 34 can be seen in FIG. 5. Both side turbines protrude sideways from the conventional wind flow path on the outside of the truck cabin 35. In order to prevent injury, the turbines are enclosed in a housing 36 which joins a conical air intake duct 37. If the cabin's walls are slopped as in the figure, the duct and wall direct air towards a turbine. The turbine may be joined to a battery bank (not illustrated in the figure) which is collected to the cabin 35 or the trailer 38 of the truck's air conditioning unit or lighting units.

The invention also envisages the use of air intake ducts located on the fuselage of an airplane with may open and close on demand to channel air towards one or more turbines located inside the airplane fuselage to power the refrigeration units or the climate controlling unit of the airplane or other on-board power consuming device such as emergency lighting units.

The invention also envisage tie use of an air intake duct on a boat to drive on-board turbines to convert wind power to electricity in order to power for example tie on-board emergency lighting units.

1. A vehicle comprising an air flow to electrical energy converter configured to be driven primarily by the air through which a vehicle travels.

2. A vehicle according to claim 1, wherein said converter incorporates a turbine located downstream from a vehicle's spoiler and positioned so that only a portion of the turbine is exposed to the air.

3. (canceled)

4. (canceled)

5. (canceled)

6. (canceled)

7. A vehicle according to claim 2, wherein means are provided to adjust the relative position of the spoiler and turbine during the motion of the vehicle.

8. (canceled)

9. A vehicle according to claim 1, wherein a duct is provided to channel air to a turbine of said converter.

10. A vehicle according to claim 1, wherein the converter incorporates a turbine whose axis of rotation is substantially parallel to the surface of the vehicle and substantially perpendicular to the direction of motion.

11. A vehicle according to claim 1, wherein the converter incorporates at least one turbine in the horizontal direction and another turbine in the vertical direction.

12. A vehicle according to claim 1, wherein the converter stores energy in a battery located in the chassis of the vehicle.
